(19) United States
(12) Patent Application Publication
(10) Pub. No.: US 2007/0035218 A1
(43) Pub. Date: Feb. 15, 2007

(54) Anti-slant device for a cabinet with multiple drawers

(76) Inventors: Kung-Cheng Chen, Taichung Hsien (TW); Lung-Chuan Huang, Taichung Hsien (TW)

Correspondence Address: Connolly Bove Lodge & Hutz LLP, P.O. Box 2207, Wilmington, DE, 19899-2207, US

(21) Appl. No.: 11/203,080

(22) Filed: Aug. 12, 2005

(51) Int. Cl. E05C 7/06

(52) U.S. Cl. 312/221

(57) ABSTRACT

An anti-slant device for a cabinet with multiple drawers includes an actuator extending from a back of each of the multiple drawers. A base is secured on a back of the cabinet and corresponding to the actuators extending from each of the multiple drawers. The base has a holder mounted on a top thereof. A slider is slidably mounted on the base and longitudinally moved relative to the base. Each actuator extends through the slider for upwardly/downward drive the slider. A buckle is disposed on a top of the slider and linearly corresponds to the holder. The buckle is received in the holder to hold the slider in place when one of the drawers is pull out of the cabinet.

### BACKGROUND OF THE INVENTION

1. Field of the Invention

The present invention relates to an anti-slant device, and more particularly to an anti-slant device for a cabinet with multiple drawers.

2. Description of Related Art

A drawer is widely used in much furniture, such as a table, a cabinet or a wardrobe, for containing objects. The conventional drawer may have lock for locking the drawer. However, the lock usually has a complicated structure and is operated with a key such that the manufacturing cost of the drawer is raised. In addition, the drawer may not be always maintained in a locked condition. Furthermore, the cabinet always has multiple drawers and the conventional drawer has no automatic locking device for locking the drawer when the drawer is closed to prevent the drawer from accidentally opening. The cabinet may be slanted and toppled down when all of the drawers are accidentally opening. Consequently, the conventional drawer is inconvenient to operate.

The present invention has arisen to mitigate and/or obviate the disadvantages of the conventional cabinet that has multiple drawers.

### SUMMARY OF THE INVENTION

The main objective of the present invention is to provide an improved anti-slant device for a cabinet with multiple drawers.

To achieve the objective, the anti-slant device in accordance with the present invention comprises an actuator extending from a back of each of the multiple drawers. A base is secured on a back of the cabinet and corresponding to the actuators extending from each of the multiple drawers. The base has a holder mounted on a top thereof. A slider is slidably mounted on the base and longitudinally moved relative to the base. Each actuator extends through the slider for upwardly/downward drive the slider. A buckle is disposed on a top of the slider and linearly corresponds to the holder. The buckle is received in the holder to hold the slider in place when one of the drawers is pull out of the cabinet.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective schematic view of an anti-slant device for a cabinet with multiple drawers;

FIG. 2 is a partially exploded perspective view of the anti-slant device of the present invention;

FIG. 3 is a side cross-sectional view of the anti-slant device of the present invention when the drawers are in an original condition;

FIG. 4 is a first operational view of the anti-slant device of the present invention when one of the drawers is pulled;

FIG. 5 is a second operational view of the anti-slant device of the present invention when the actuator is departed from the slider;

FIG. 6 is a third operational view of the anti-slant device of the present invention for showing the pulled drawer moved back to the original condition;

FIG. 7 is a side cross-sectional view of a second embodiment of the anti-slant device in accordance with the present invention; and

FIG. 8 is an operational view of the anti-slant device in FIG. 7.

### DETAILED DESCRIPTION OF THE INVENTION

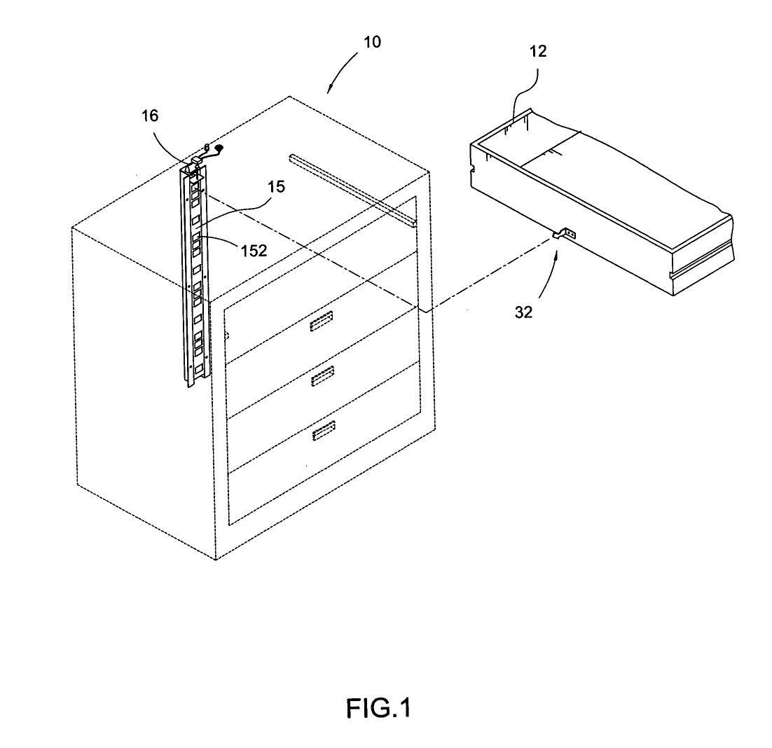

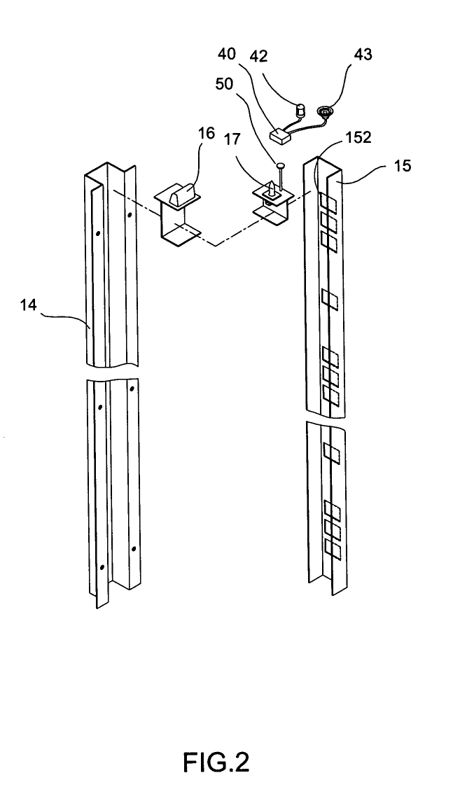

Referring to the drawings and initially to FIGS. 1-3, an anti-slant device for a cabinet with multiple drawers in accordance with the present invention comprises an actuator (13) extending from a back of each of the multiple drawers (12). The actuator (13) has a drive portion (32) formed on a free end thereof and a stopper (34) formed under the drive portion (32). The drive portion (32) forms a first ramp (321), a second ramp (322) parallel to each other.

A base (14) is secured on a back of the cabinet (10) and corresponding to the actuator (13) extending from each of the multiple drawers (12). The base (14) has a holder (16) mounted on a top thereof.

A slider (15) is slidably mounted on the base (10) and longitudinally moved relative to the base (10). A series of square through holes (152) is defined in the slider (15). Each actuator (13) extends through a corresponding one of the square through holes (152) when being closed. A buckle (17) is disposed on a top of the slider (15) and linearly corresponds to the holder (16). The buckle (17) is received in the holder (16) to hold the slider (15) in place when one of the drawers (12) is pulled out of the cabinet (10).

A proximity sensor (40) is mounted on an inner side of the top (111) of the cabinet (10) and longitudinally corresponding to the top of the slider (15). A magnetic element (50) longitudinally extends from the top of the slider (15) and linearly corresponding to the proximity sensor (40). In the preferred embodiment of the present invention, the magnetic element (50) is a magnet. A lighting element (42) is secured on an outer side of the top (111) of the cabinet (10) and electrically connected to the proximity sensor (40). In the preferred embodiment of the present invention, the lighting element (42) is a light bulb. A sound element (43) is mounted on the top (111) of the cabinet (10) and electrically connected to the proximity sensor (40).

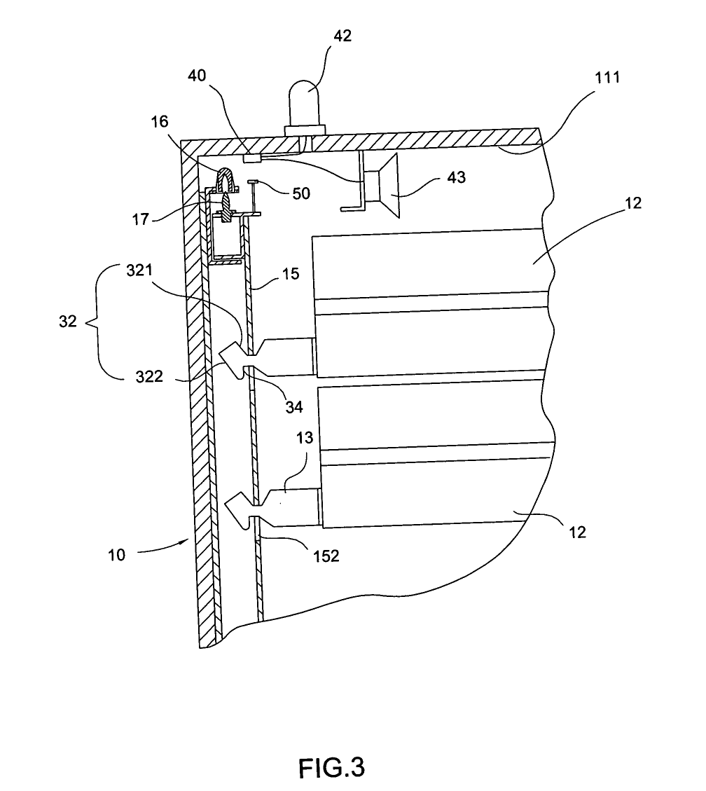

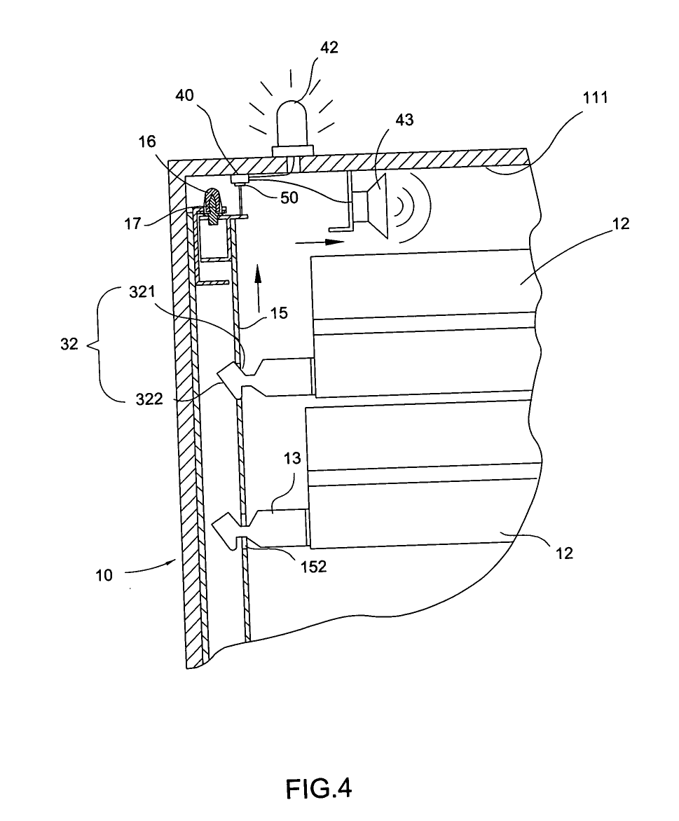

With reference to FIG. 3, the buckle (17) is departed from the holder (16) when the drawers are in an original condition. With reference to FIG. 4, the first ramp (321) upwardly pushes a top edge of the corresponding square through hole (152) in slider (15) when one of the drawers (12) is outward pulled. The slider (15) is upwardly moved due to the first ramp (321) and positioned when the buckle (17) inserted into and received in the holder (16).

At the same time, the magnetic element (50) is moved toward the proximity sensor (40). The proximity sensor (40) lights the lighting element (42) and sounds the sound element (43) for reminding the user when the magnetic element (50) moved with a sensing scope of the proximity sensor (40).

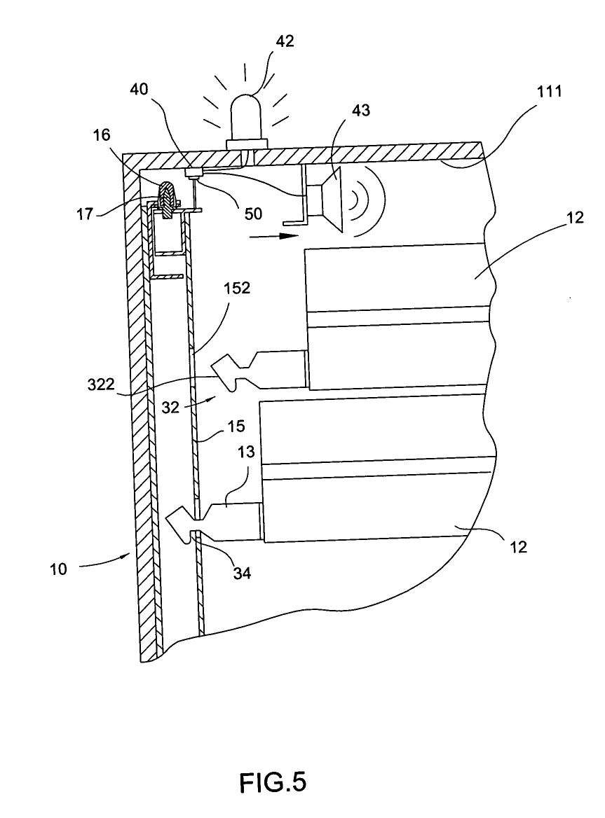

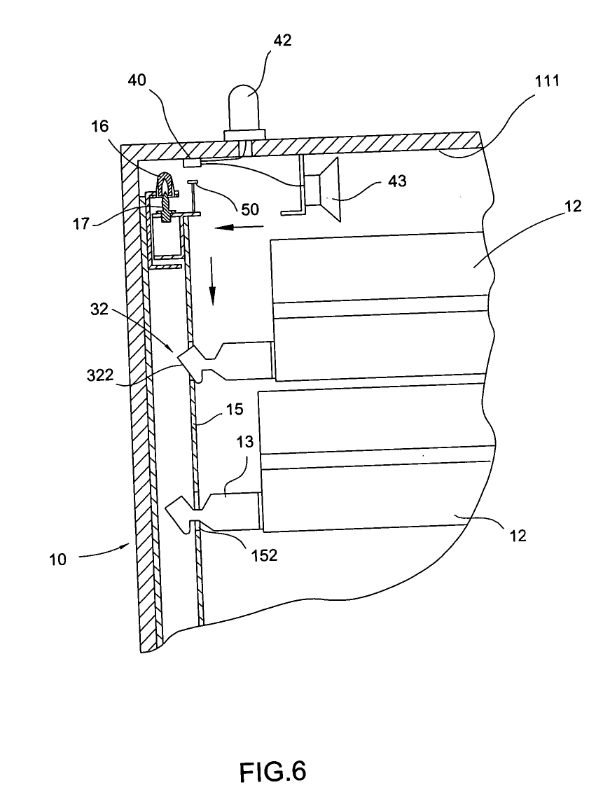

With reference to FIG. 5, the closed drawers (12) is locked when after one of the drawers (12) is opened because the stopper (34) is engaged to an lower edge of the corresponding square through hole (152) of the upwardly moved slider (15). As a result, the only one of the drawers (12) can be opened such that the gravity of the cabinet (10) does not overly moved relative the opened drawer (12). Consequently, the cabinet (10) with the present invention does not be toppled and fell due to too many opened drawers (12). With reference to FIG. 6, the second ramp (322) downward pushes the lower edge of the corresponding square through hole (152) to downward move the slider (15) and make the buckle (17) detach from the holder (16). Consequently, all the drawers (12) are in a free condition, and the lighting element (42) and the sound element (43) are stopped because the magnetic element (50) is moved away from the proximity sensor (40).

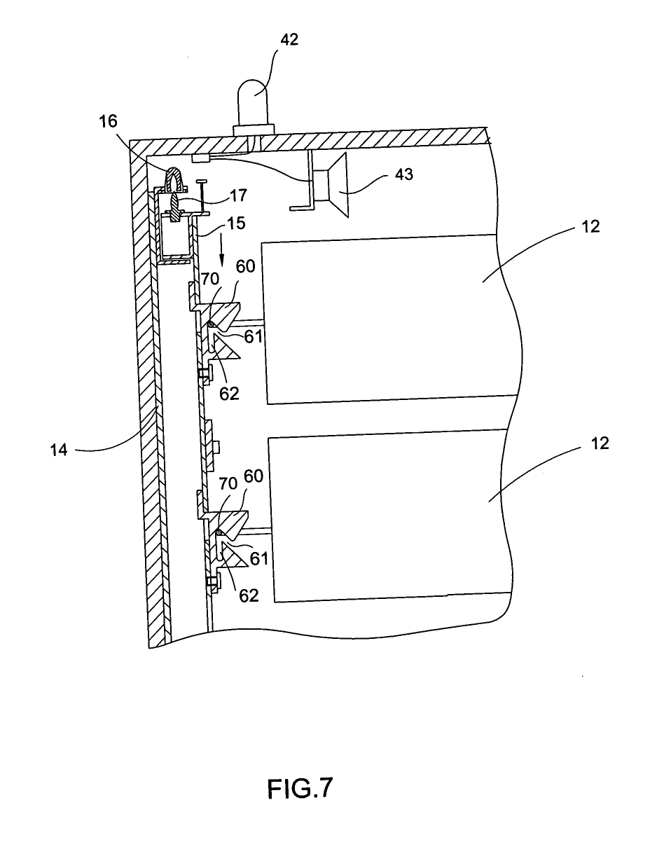

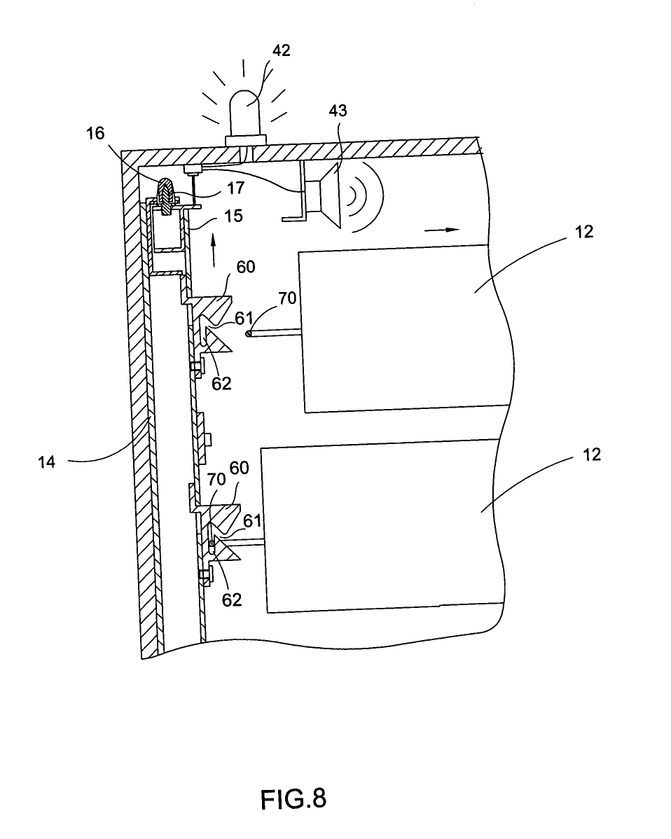

With reference to FIGS. 7 and 8 that show a second embodiment of the anti-slant device in accordance with the present invention, in the embodiment, the base (14), the holder (16), the buckle (17), the proximity sensor (40), the magnetic element (50), the lighting element (42) and the sound element (43) are the same as the above embodiment. The anti-slant device comprises an L-shaped rod (70) extending from a back of each of the drawers (12). Multiple blocks (60) are secured on the slider (15) and each block (60) linearly aligning with a corresponding one of the L-shaped rods (70). Each block (60) has a slanted groove (61) upwardly and inward extending from a front end thereof and a vertical groove (62) defined in the block (60). The vertical groove (62) has an upper end communicating with that of the slanted groove (61). The L-shaped rod (70) is partially and laterally received in block (60), where the slanted groove (61) and the vertical groove (62) communicate with each other, when the drawer (12) is closed. The L-shaped rod (70) moved along the top side of the slanted groove (61) to lift up the block (60) with the slider (15) when one of the drawers (12) is outwardly pulled. The L-shaped rods (70) of the other closed drawers (12) are received in the vertical groove (62) and the drawers (12) are locked because the slider (15) with the blocks (60) are lifted and positioned due to the holder (16) and the buckle (17). As described in the first embodiment of the present invention, the lighting element (42) and the sound element (43) is operated due to the proximity sensor (40) and the magnetic element (50). The L-shaped rod (70) of the closing drawer (12) is moved along a lower side of the slanted groove (61) to downward move the slider (15) with the blocks (60). Consequently, all of the drawers (12) are in a free condition after the slider (15) and the blocks (60) are moved to the original location.

Although the invention has been explained in relation to its preferred embodiment, it is to be understood that many other possible modifications and variations can be made without departing from the spirit and scope of the invention as hereinafter claimed.

What is claimed is:

1. An anti-slant device for a cabinet with multiple drawers, comprising:
an actuator extending from a back of each of the multiple drawers, the actuator having a drive portion formed on a free end thereof and a stopper formed under the drive portion;
a base adapted to be secured on a back of the cabinet and corresponding to the actuator extending from each of the multiple drawers, the base having a holder mounted on a top thereof;
a slider slidably mounted on the base and longitudinally moved relative to the base, a series of square through holes defined in the slider, each actuator extending through a corresponding one of the square through holes when being closed, a buckle disposed on a top of the slider and linearly corresponds to the holder, the buckle received in the holder to hold the slider in place when one of the drawers is pull out of the cabinet;
a proximity sensor adapted to be mounted on the cabinet and longitudinally corresponding to the top of the slider, a magnetic element longitudinally extending from the top of the slider and linearly corresponding to the proximity sensor, a lighting element adapted to be secured on the cabinet and electrically connected to the proximity sensor, a sound element adapted to be mounted on the cabinet and electrically connected to the proximity sensor, the lighting element and the sound element operated when one of the drawers is outwardly pulled.

2. The anti-slant device as claimed in claim 1, wherein the actuator has a drive portion formed on a free end thereof and a stopper formed under the drive portion, the drive portion forming a first ramp and a second ramp parallel to each other, wherein the first ramp lifts the slider when one of the drawers is outwardly pulled, the second ramp downward moves the slider when the opened drawer is closed and the stopper of the closed drawers is engaged to the slider when one of the drawers is opened.

3. The anti-slant device as claimed in claim 1, wherein the magnetic element is a magnet.

4. The anti-slant device as claimed in claim 1, wherein the lighting element is secured on an outer side of the top of the cabinet and the sound element is mounted on an inner side of the top of the cabinet.

5. An anti-slant device for a cabinet with multiple drawers, comprising:
an L-shaped rod extending from a back of each of the drawers;
a base adapted to be secured on a back of the cabinet and corresponding to the L-shaped rods extending from each of the multiple drawers, the base having a holder mounted on a top thereof;
a slider slidably mounted on the base and longitudinally moved relative to the base, multiple blocks secured on the slider and each block linearly aligning with a corresponding one of the L-shaped rods, the L-shaped rod partially and laterally received in the block for upwardly/downward driving the slider, a buckle disposed on a top of the slider and linearly corresponds to the holder, the buckle received in the holder to hold the slider in place when one of the drawers is pull out of the cabinet;
a proximity sensor adapted to be mounted on the cabinet and longitudinally corresponding to the top of the slider, a magnetic element longitudinally extending from the top of the slider and linearly corresponding to the proximity sensor, a lighting element adapted to be secured on the cabinet and electrically connected to the proximity sensor, a sound element adapted to be mounted on the cabinet and electrically connected to the proximity sensor, the lighting element and the sound element operated when one of the drawers is outwardly pulled.

6. The anti-slant device as claimed in claim 5, wherein each block has a slanted groove upwardly and inward extending from a front end thereof and a vertical groove defined in the block, the vertical groove having an upper end communicating with that of the slanted groove, wherein the L-shaped rod is moved along the top side of the slanted groove to lift up the block with the slider when one of the drawers is outwardly pulled and the L-shaped rods of the other closed drawers are received in the vertical groove and the drawers are locked.
